(19) United States
(12) Patent Application Publication
(10) Pub. No.: US 2013/0050273 A1
(43) Pub. Date: Feb. 28, 2013

(54) DISPLAY DEVICE, DISPLAY SYSTEM, DISPLAYING METHOD, AND PROGRAM

(71) Applicant: Ryuuichi Fujimura, Tokyo (JP)

(72) Inventor: Ryuuichi Fujimura, Tokyo (JP)

(73) Assignee: NEC Display Solutions, Ltd., Tokyo (JP)

(21) Appl. No.: 13/642,835

(22) PCT Filed: Apr. 23, 2010
(86) PCT No.: PCT/JP2010/002960

§ 371 Date: Oct. 22, 2012

(51) Int. Cl. G09G 5/00

(52) U.S. Cl. 345/668

(57) ABSTRACT

A display device includes: an image processing unit receiving an input of magnification ratio information indicating a magnification ratio of an image, and an image signal indicating the image, the image processing unit performing on the image signal, image processing which changes an image size of the image signal according to the magnification ratio; an image quality processing receiving an input of an image signal undergone the image processing, and the magnification ratio information, the image quality processing unit changing a sharpness frequency characteristic preliminarily determined according to the image, according to the magnification ratio, the image quality processing unit performing sharpness processing which emphasizes a frequency component of the image signal undergone the image processing, based on the changed sharpness frequency characteristic; and a display unit displaying on a display screen, an image based on the image signal sharpness-processed by the image quality processing unit.

### TECHNICAL FIELD

The present invention relates to a display device including a plurality of displays, a display system, a displaying method, and a program.

### BACKGROUND ART

In a display system that uses a plurality of displays to display video images, or the like (hereunder, referred to as a multi-image system), for example, there is a method of using a video image decomposer with a function of decomposing a display target video image into video images to be displayed on the respective displays, and distributing the video images to the respective displays.

On the other hand, there is a method in which the same video image is distributed to all displays, each display uses its own function to clip a desired region of the distributed video image, and enlarges it at a desired magnification ratio to display, and the video image is displayed using the plurality of displays.

The present invention relates to the latter one.

In general, as a method of adjusting the sharpness of an image displayed by a display, there is a method (including batch processing performed by a filter), of extracting a frequency component that indicates the outline of the image, and adding it to the original signal.

In this case, a sharpness frequency characteristic associated with the amount of sharpness adjustment (hereunder, referred to as sharpness level) is preliminarily determined, and a table that indicates this association relationship is stored in a storage unit built into the display. Then when sharpness processing at a sharpness level according to the preference of a user is instructed, a sharpness circuit built into the display makes reference to this table, and performs sharpness processing for emphasizing the frequency component of the target image signal based on the sharpness frequency characteristic according to the sharpness level, to thereby adjust the sharpness of the image.

For example, there is a multi-image system in which a reproduction device that controls each display, includes an image rendering unit corresponding to each display, and it changes the display state of each display in the case where it receives an input of operation information that changes the setting of the display state of the display (for example, refer to Patent Document 1).

### PRIOR ART DOCUMENT

### Patent Document

[Patent Document 1] Japanese Unexamined Patent Application, First Publication No. 2005-274937

### SUMMARY OF THE INVENTION

### Problem to be Solved by the Invention

However, the reproduction device such as disclosed in Patent Document 1 makes reference to the table that associates preliminarily determined sharpness levels and sharpness frequency characteristics with each other, to adjust the sharpness of an image. Consequently, there has been a problem in that in the case where, for example, the magnification ratio of an image to be displayed is different between the plurality of displays included in the display system, sharpness may not be applied to some of the displays.

This problem is specifically described, with reference to FIG. 10.

The sharpness frequency characteristic is such that the optimum value to be emphasized in the sharpness processing is determined according to; the frequency component of the image signal (replaced by analog in the case of digital), the total number of pixels of the display, or the number of pixels of the image and the image size.

On the other hand, each display in the multi-image system, in the case of displaying a single image together with the other displays, may magnify the image size for display in some cases. The image signal that has undergone the image processing for magnifying the image size is such that the frequency component included in this image signal also changes according to the image processing.

As shown in FIG. 10(a), for example, in the case where an image that is suitable for the screen size is being displayed on a display, as the optimum value to be emphasized for applying sharpness to the image (sharpness frequency characteristic), a frequency component with a frequency f₀ being a peak in the horizontal direction of the screen is preliminarily determined. This optimum value is preliminarily determined by the frequency component and the like included in the image signal as described above, and for example, image signals having the same number of pixels and image size are such that the frequency component with the same frequency f₀ being a peak is preliminarily determined as the optimum value.

For example, in a multi-image system where two screens are arranged and used in the horizontal direction and in the vertical direction as shown in FIG. 10(b), using four of the displays shown in FIG. 10(a), in the case where the image size is magnified to display on all of the screens of the four displays, image processing for magnifying the image size by two times is performed on the image signal. As a result, the optimum frequency component relatively becomes ½. Therefore, the optimum value for the sharpness frequency characteristic needs to be a frequency component with a peak of frequency f₀/2.

Moreover, similarly, in a multi-image system where three screens are arranged and used in the horizontal direction and in the vertical direction as shown in FIG. 10(c), using nine of these displays, in the case where the image size is magnified to display on all of the screens of the nine displays, image processing for magnifying the image size by three times is performed on the image signal. As a result, the optimum frequency component relatively becomes ⅓. Therefore, the optimum value for the sharpness frequency characteristic needs to be a frequency component with a peak of frequency f₀/3.

Although not shown in the figure, also in the vertical direction of the display screen, similarly, the optimum value for the sharpness frequency characteristic relatively changes according to the magnification of the image size.

However, as described in the background art, the table stored in the sharpness circuit is a table that associates a preliminarily determined sharpness adjustment amount and sharpness frequency characteristic with each other regardless of the magnification ratio of the image size. Therefore, in the case where this sharpness circuit performs sharpness processing on the image signal that has undergone the image processing for magnifying the image size as shown in FIGS. 10(b) and (c), then as shown in FIG. 10(a), the frequency component with a peak of frequency f₀ in the horizontal direction of the screen is emphasized, and sharpness is not applied.

That is to say, as can be understood from FIG. 10, no frequency component containing frequency f₀ is present in the image signals that have undergone the image processing by the image processing unit for magnifying the image size by two times or three times. Therefore, there is a problem in that the sharpness circuit emphasizes the frequency component that is not present, and sharpness will not be visually applied.

The present invention takes into consideration the above circumstances, and has been achieved in order to solve the above problems, with an object of providing, in a multi-image system including a plurality of displays, a display device, a display system, a displaying method, and a program for appropriately performing sharpness processing on an image signal output from image processing that changes the image size.

### Means for Solving the Problem

In order to solve the above problems, a display device according to the present invention includes: an image processing unit which receives an input of magnification ratio information indicating a magnification ratio of an image, and an image signal indicating the image, the image processing unit performing on the image signal, image processing which changes an image size of the image signal according to the magnification ratio; an image quality processing unit which receives an input of an image signal undergone the image processing, and the magnification ratio information, the image quality processing unit changing a sharpness frequency characteristic preliminarily determined according to the image, according to the magnification ratio indicated by the magnification ratio information, the image quality processing unit performing sharpness processing which emphasizes a frequency component of the image signal undergone the image processing, based on the changed sharpness frequency characteristic; and a display unit which includes a display screen, and displays on the display screen, an image based on the image signal sharpness-processed by the image quality processing unit.

Moreover, in order to solve the above problems, a display device according to the present invention includes: an image processing unit which receives an input of magnification ratio information indicating a magnification ratio of an image, and an image signal indicating the image, the image processing unit performing on the image signal, image processing which changes an image size of the image signal according to the magnification ratio; an image quality processing unit which includes a plurality of sharpness circuits receiving an input of the image signal undergone the image processing, and the magnification ratio information, the sharpness circuits performing sharpness processing which emphasizes a frequency component of the image signal undergone the image processing, based on a sharpness frequency characteristic preliminarily determined according to the magnification ratio, the image quality processing unit selecting the sharpness circuit according to the magnification ratio indicated by the magnification ratio information; and a display unit which includes a display screen, and displays on the display screen, an image based on the image signal sharpness-processed by the image quality processing unit.

Furthermore, in order to solve the above problems, a display system according to the present invention includes: a plurality of the above display devices, and a display control device which performs display control of the display devices, and the display control device outputs to each of the display devices, the image signal and the magnification ratio information according to a connection manner of the display devices.

Moreover, in the above display system, the display control device may output to the display devices, the magnification ratio information indicating different magnification ratios.

Furthermore, in order to solve the above problems, a display method according to the present invention includes: an image processing step of receiving an input of magnification ratio information indicating a magnification ratio of an image, and an image signal indicating the image, and performing on the image signal, image processing which changes an image size of the image signal according to the magnification ratio; an image quality processing step of: receiving an input of an image signal undergone the image processing, and the magnification ratio information, changing a sharpness frequency characteristic preliminarily determined according to the image, according to the magnification ratio indicated by the magnification ratio information, and performing sharpness processing which emphasizes a frequency component of the image signal undergone the image processing, based on the changed sharpness frequency characteristic; and a displaying step of displaying on a display screen, an image based on the image signal undergone the sharpness processing.

Moreover, in order to solve the above problems, a program according to the present invention is for making a computer function as: an image processing means which receives an input of magnification ratio information indicating a magnification ratio of an image, and an image signal indicating the image, the image processing means performing on the image signal, image processing which changes an image size of the image signal according to the magnification ratio; an image quality processing means which receives an input of an image signal undergone the image processing, and the magnification ratio information, the image quality processing means changing a sharpness frequency characteristic preliminarily determined according to the image, according to the magnification ratio indicated by the magnification ratio information, the image quality processing means performing sharpness processing which emphasizes a frequency component of the image signal undergone the image processing, based on the changed sharpness frequency characteristic; and a display means which displays on a display screen, an image based on the image signal undergone the sharpness processing.

### Effect of the Invention

According to the present invention, in a multi-image system including a plurality of displays, it is possible to appropriately perform sharpness processing on an image signal output from image processing that changes the image size.

### BRIEF DESCRIPTION OF THE DRAWINGS

FIG. 1 is a diagram showing an example of a parallel connection display system according to a first exemplary embodiment.

FIG. 2 is a diagram showing an example of a serial connection display system according to the first exemplary embodiment.

FIG. 3 is a block diagram showing an example of a configuration of a display control device according to the first exemplary embodiment.

FIG. 4 is a block diagram showing an example of a configuration of a display according to the first exemplary embodiment.

FIG. 5 is a diagram for describing a situation where the peak value of a frequency characteristic of sharpness changes according to a magnification ratio.

FIG. 6 is a flow chart showing an example of a process flow of the display system according to the first exemplary embodiment.

FIG. 7 is a diagram for describing a second exemplary embodiment.

FIG. 8 is a block diagram showing an example of a configuration of a display control device according to a third exemplary embodiment.

FIG. 9 is a block diagram showing an example of a configuration of a display according to the third exemplary embodiment.

FIG. 10 is a diagram for describing a problem related to the present exemplary embodiment.

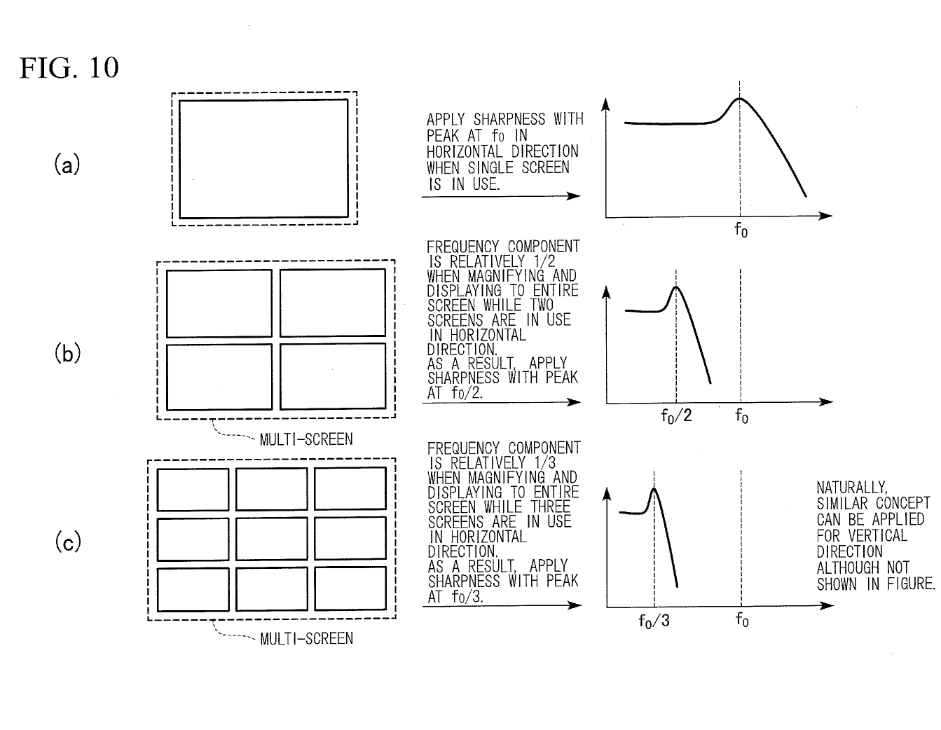

### EMBODIMENTS FOR CARRYING OUT THE INVENTION

### First Exemplary Embodiment

Next, an exemplary embodiment for carrying out the invention is described in detail, with reference to the drawings.

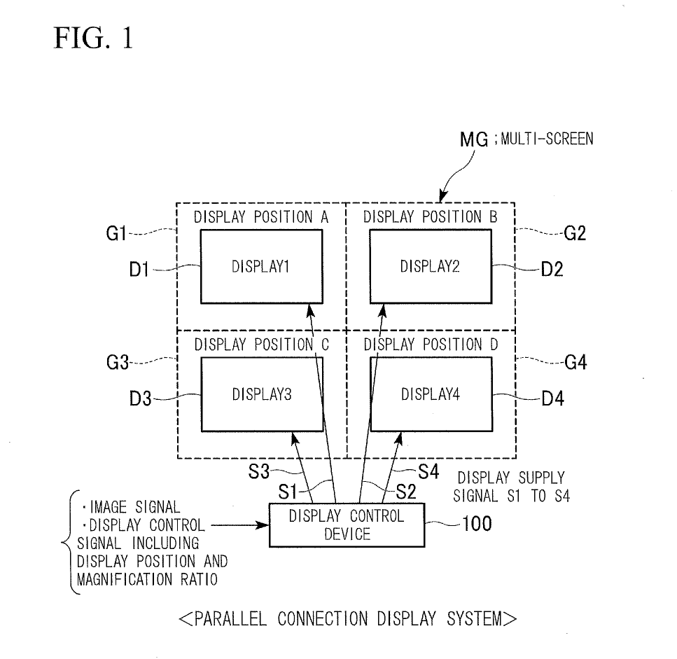

FIG. 1 is a diagram showing an example of a display system according to the present exemplary embodiment.

As shown in FIG. 1, the display system includes a display control device 100, and a plurality of display devices (hereunder, referred to as displays) D1 to D4 each connected parallelly to this display control device 100. A configuration with the display control device 100 and the displays D1 to D4 connected in parallel in this manner is hereunder referred to as a parallel connection display system.

The displays D1 to D4 respectively include screens G1 to G4 of the same size for example. The screens G1 and G2, and the screens G3 and G4 are respectively arranged in the horizontal direction, and the screens G1 and G3 and the screens G2 and G4 are respectively arranged in the vertical direction. The four screens G1 to G4 constitute a single multi-screen MG.

The display control device 100 is connected to an image supply device 200. The display control device 100 receives inputs of image signals and display control signals from the image supply device 200.

Image signals are data that represent an image to be displayed on the displays D1 to D4. Display control signals include display enlargement factor information that indicates the enlargement factor of the size of an image to be displayed on the displays D1 to D4, display position information that indicates the display position on the multi-screen MG, or display sharpness level information that indicates the degree of adjustment to be made to the sharpness of the image quality. A display position is a position on the multi-screen MG, and for example, display positions corresponding to the screens G1 to G4 are each taken as display positions A to D. Display sharpness level information is a type of information that indicates in a phased manner the degree of outline emphasis, for example, from a sharpness level “0” indicating that no sharpness processing is to be performed to a sharpness level “+5” indicating that the outline is to be emphasized to the highest extent.

In order to facilitate the description, the display control device 100 and the image supply device 200 are treated as independent devices. However either one of these may include both of the functionalities.

The display control device 100 supplies input image signals and display control signals to the respective displays D1 to D4. The signals supplied to the respective displays D1 to D4 from the display control device 100 are hereunder referred to as display supply signals S1 to S4.

The displays D1 to D4 receive inputs of the display supply signals S1 to S4, and display images based on these display supply signals S1 to S4.

Here, in order to facilitate the description, a display system including four displays is described as an example. However, the present invention is not limited to this, and the display system may be configured with nine displays D1 to D9 where three displays are arranged in the horizontal direction and three displays are arranged in the vertical direction, or the configuration may combine more displays.

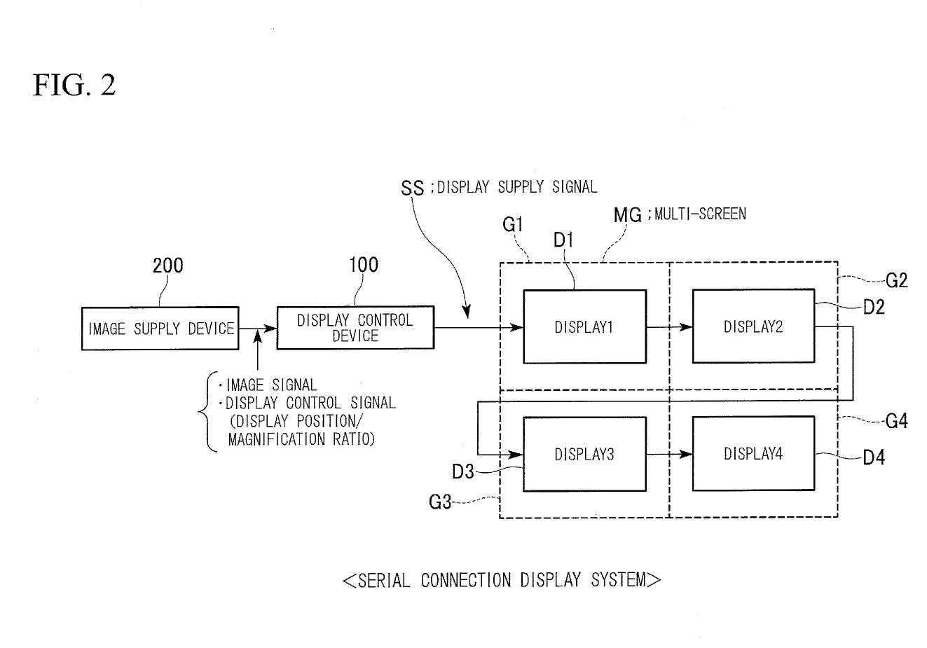

Moreover, the display system according to the present exemplary embodiment is not limited to the configuration including displays D1 to D4 connected in parallel to the display control device 100 as described above (parallel connection display system), and may be a configuration with displays D1 to D4 connected in series to the display control device as shown in FIG. 2 for example. A configuration with the display control device 100 and the displays D1 to D4 connected in parallel in this manner is hereunder referred to as a serial connection display system.

To describe specifically, as shown in FIG. 2, the displays D1 to D4 are connected in series in the order of D1 to D4. Among these, the display D1 is connected to the display control device 100. The displays D1 to D4 output the input signals to the display connected to their output side.

The display control device 100 supplies input image signals and display control signals to the respective displays D1 to D4. Here, the signal supplied to each display D1 from the display control device 100 is hereunder referred to as a display supply signal SS.

The display supply signal SS, for example, may include a single image signal and a single display control signal, and may be a signal that supplies the same image signal and the same display control signal to all of the displays D1 to D4.

Moreover, it is not limited to this, and the display supply signal SS may include image signals and display control signals that respectively correspond to the displays D1 to D4. That is to say, the display control device 100 may output, to the display D1, an image signal and a display control signal that are associated with identification information (for example, identification information ID 1 to 4 with respect to the displays D1 to D4) preliminarily determined with respect to each of the displays D1 to D4. In this case, the displays D1 to D4 may receive input of an image signal and a display control signal associated with the identification information ID 1 to 4 assigned thereto from the display supply signal SS input from the display control device 100, and may display the image based on the image signal and the display control signal.

The display control device 100 functions as a parallel connection display system or a serial connection display system by receiving input of operation signals from the displays D1 to D4, or by setting the display positions of each of the displays D1 to D4 from an operating unit such as a remote controller or a control panel. Therefore, although not shown in the figure, the display control device 100 includes a connection unit which receives input of an operation signal from the displays D1 to D4, and a communication unit which receives the operation signal from the operation unit.

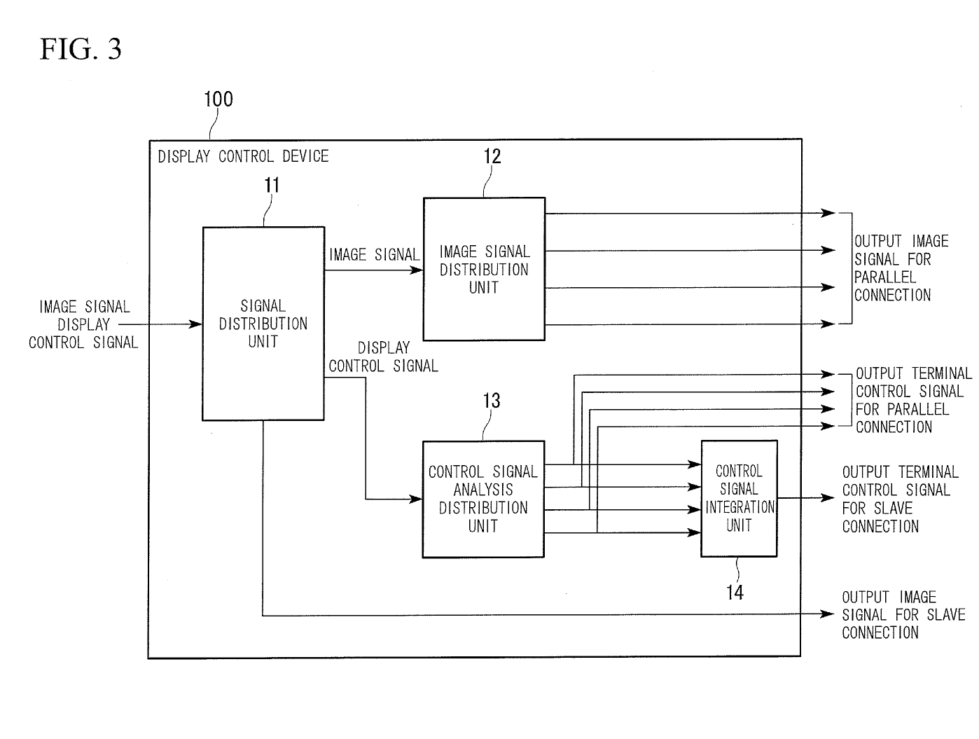

Next, an example of a configuration of the display control device 100 is described, with reference to FIG. 3. FIG. 3 is a block diagram showing an example of a configuration of the display control device 100.

As shown in FIG. 3, the display control device 100 includes a signal differential unit 11, an image signal distribution unit 12, a control signal analysis distribution unit 13, and a control signal integration unit 14.

The signal differential unit 11 distributes an image signal and a display control signal input from the image supply device 200, to thereby output the image signal to the image signal distribution unit 12, and the display control signal to the control signal analysis distribution unit 13. Moreover, in the case of functioning as a serial connection display system, the signal differential unit 11 outputs the distributed image signal directly to the display D1 without outputting the image signal to the image signal distribution unit 12.

In the case of functioning as a parallel connection display system, the image signal distribution unit 12 outputs the image signal input from the signal analysis unit 11 to each of the displays D1 to D4. That is to say, the image signal distribution unit 12 duplicates an image signal and distributes them to each of the displays D1 to D4.

The control signal analysis distribution unit 13 analyzes the display control signal input from the signal analysis unit 11, and distributes it into terminal control signals corresponding to the respective displays D1 to D4. In the case of functioning as a parallel connection display system, the control signal analysis distribution unit 13 outputs the distributed terminal control signals to the respective displays D1 to D4. On the other hand, in the case of functioning as a serial connection display system, the control signal analysis distribution unit 13 assigns identification information ID 1 to 4 of the respective displays D1 to D4 to the terminal control signals distributed to the respective displays D1 to D4, and outputs them to the control signal integration unit 14.

To describe specifically, the control signal analysis distribution unit 13 obtains by analysis, terminal position information that indicates display positions A to C of the image to be displayed on the respective displays D1 to D4, based on the display position information included in the display control signal. Moreover, the control signal analysis distribution unit 13 obtains by analysis, terminal magnification ratio information that indicates the magnification ratio of the image size to be displayed on the respective displays D1 to D4, based on the display magnification ratio information included in the display control signal. Furthermore, the control signal analysis distribution unit 13 obtains by analysis, terminal magnification ratio information that indicates the sharpness level of the image to be displayed on the respective displays D1 to D4, based on the display sharpness level information included in the display control signal.

The control signal analysis distribution unit 13 outputs the terminal control signal including the terminal position information, the terminal magnification ratio information, and the terminal sharpness level information obtained by analysis, to the respective displays D1 to D4 or to the control signal integration unit 14.

In the case of functioning as a serial connection display system, the control signal integration unit 14 integrates the terminal control signals input from the control signal analysis distribution unit 13, and outputs it to the display D1.

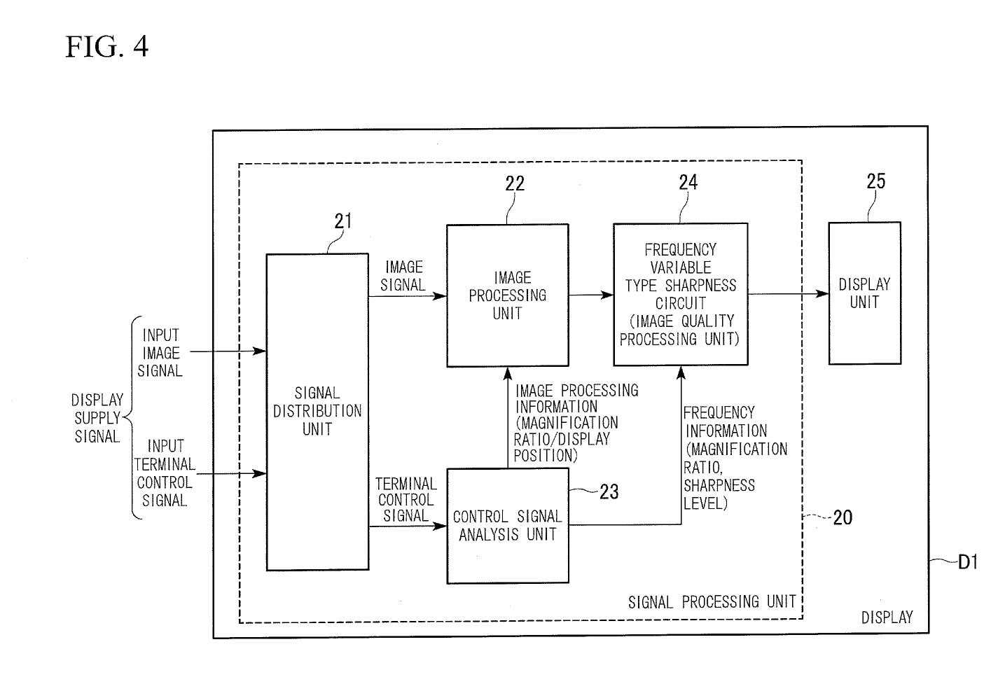

Next, an example of a configuration of the display D1 is described, with reference to FIG. 4. FIG. 4 is a block diagram showing an example of a configuration of the display D1. The displays D1 to D4 all have the same configuration, and the display D1 is described as an example hereunder.

The display D1 includes a signal processing unit 20 and a display unit 25. This signal processing unit 20 includes a signal differential unit 21, an image processing unit 22, a control signal analysis unit 23, and a frequency variable type sharpness circuit (image quality processing unit) 24.

The signal differential unit 21 receives input of an image signal and a terminal control signal serving being the display supply signal S1, from the display control device 100. It separates them and outputs the image signal to the image processing unit 22, and outputs the terminal control signal to the control signal analysis unit 23.

The control signal analysis unit 23 analyzes the input terminal control signal, and obtains terminal magnification ratio information, terminal position information, and terminal sharpness level information included in the terminal control signal. This control signal analysis unit 23 outputs the terminal magnification ratio information and the terminal position information obtained by analysis, to the image processing unit 24 as image processing information. Moreover, the control signal analysis unit 23 outputs the terminal magnification ratio information and the terminal sharpness level information obtained by analysis, to the frequency variable type sharpness circuit 24 as frequency information.

The image processing unit 22 performs image processing on the image signal input from the signal differential unit 21, based on the image processing information input from the control signal analysis unit 23, and outputs the image-processed image signal to the frequency variable type sharpness circuit 24.

The image processing unit 22 performs on the image signal, image processing for magnifying the image size, according to the terminal magnification ratio information included in the image processing information. Moreover, the image processing unit 22 cuts out the image of a corresponding portion in the image signal, based on the terminal position information included in the image processing information.

The frequency variable type sharpness circuit 24, based on the terminal magnification ratio information and the terminal sharpness level information included in the frequency information input from the control signal analysis unit 23, performs sharpness processing on the image signal input from the image processing unit 22, and outputs the sharpness-processed image signal to the display unit 25.

The display unit 25 is a device including a screen G1, and it displays on the screen G1, an image based on the image signal input from the frequency variable type sharpness circuit 24.

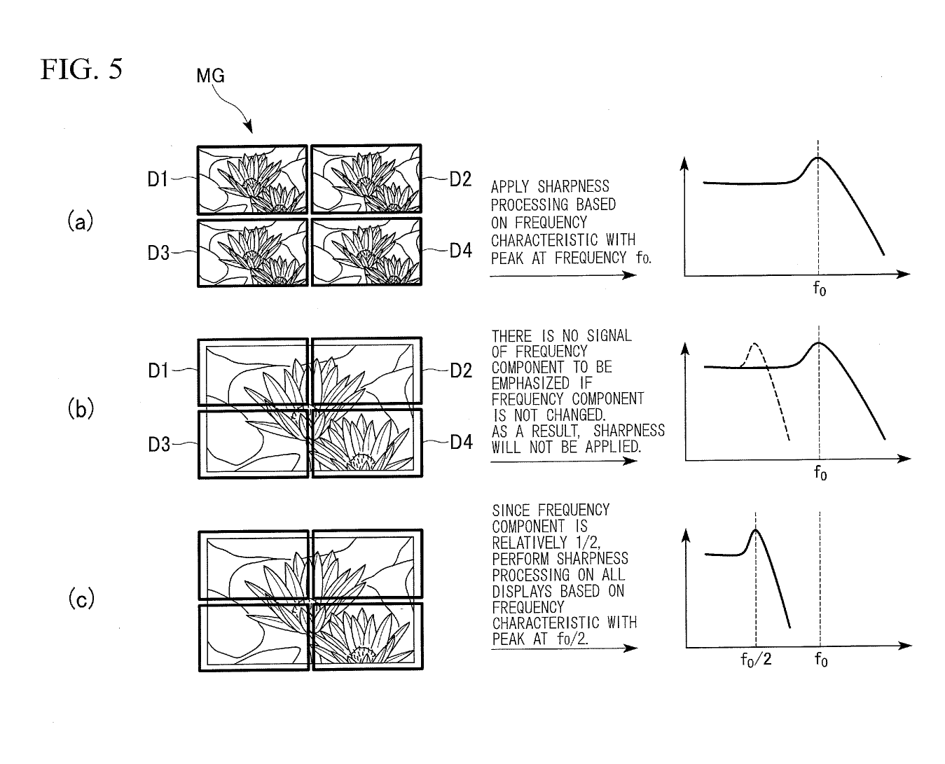

Here, an example of sharpness processing of the frequency variable type sharpness circuit 24 is described, with reference to FIG. 5. FIG. 5 is a diagram for describing a situation where the optimum value of the sharpness frequency characteristic changes according to magnification ratio. In each graph, the horizontal axis represents frequency and the vertical axis represents amplitude.

FIG. 5(a) is a diagram for describing a case where the frequency variable type sharpness circuit 24 performs sharpness processing of, for example, a sharpness level “+1”, on the respective displays D1 to D4 to adjust the sharpness of the image displayed on all of the displays D1 to D4. That is to say, the magnification ratio of the image to be displayed on each of the displays D1 to D4 is “one time”.

The optimum value of the sharpness frequency characteristic corresponding to this sharpness level “+1” is preliminarily found as being a frequency component with a peak at frequency f₀ (for example, 30 MHz) in the horizontal direction of the screen.

Consequently, as a sharpness frequency characteristic at the time of adjusting the sharpness with the sharpness level “+1”, a sharpness frequency characteristic having a frequency component with a peak at frequency f₀ in the horizontal direction of the screen is preliminarily stored in a built-in storage unit of the frequency variable type sharpness circuit 24.

Therefore, the frequency variable type sharpness circuit 24 makes reference to this storage unit, and on all of the displays D1 to D4, it performs, on the image signal, processing for emphasizing the frequency component with a peak at frequency f₀ in the horizontal direction of the screen. As a result, sharpness at the sharpness level “+1” is applied to the image displayed on the respective displays D1 to D4.

On the other hand, as shown in FIG. 5(b), in the case where a single image is to be displayed on a multi-screen MG configured with the screens G1 to G4 of the displays D1 to D4, a portion corresponding to the position on the multi-screen MG, which is the image magnified by “two times” the image size displayed on the respective displays D1 to D4, is displayed on the respective displays D1 to D4.

That is to say, in order to display on the displays D1 to D4, the image processing unit 22 performs, on the image signal, image processing for magnifying the image size by “two times”, and performs image processing for cutting out a portion of the image according to the position of each of the displays D1 to D4. In this case, the frequency component included in the image signal changes relatively according to the magnification ratio of the image size, and becomes ½. This frequency component is shown with a broken line in FIG. 5(b).

As shown in the figure, the frequency characteristic shown with the broken line is such that the peak value in the horizontal direction of the screen is frequency f₀/2 (for example, 15 MHz), and it is deviated from the frequency f₀ of the peak value of the sharpness frequency characteristic shown with the solid line (where the magnification ratio of the image size is “one time”).

Accordingly, even if the sharpness circuit performs sharpness processing for emphasizing the frequency component including the frequency f₀, on the image signal which has undergone image processing for magnifying the image size by two times by the image processing unit based on the frequency characteristic with a peak at frequency f₀ in the horizontal direction of the screen (that is, the sharpness frequency characteristic corresponding to the sharpness level “+1”), sharpness is not applied to the image signal. That is to say, as a result of the image processing for magnifying the image size by two times having been applied to the image signal, in the frequency component included in this image signal, no frequency component with a peak at frequency f₀ in the horizontal direction of the screen is present. Therefore, the sharpness circuit emphasizes the frequency component that is not present, and sharpness will not be visually applied.

Consequently, the frequency variable type sharpness circuit 24 according to the present invention is such that as shown in FIG. 5(b), when the image size is displayed as being magnified by two times, a change that makes the peak value of the sharpness frequency characteristic associated with the sharpness level ½, is made to the sharpness frequency characteristic, based on the frequency information input from the control signal analysis unit 23. The sharpness frequency characteristic after this change corresponds to the frequency characteristic shown with the solid line in FIG. 5(c).

This frequency variable type sharpness circuit 24 performs sharpness processing on the image signal based on the sharpness frequency characteristic that has been changed according to the magnification ratio. As a result, sharpness at the sharpness level “+1” is applied to the image displayed on the displays D1 to D4.

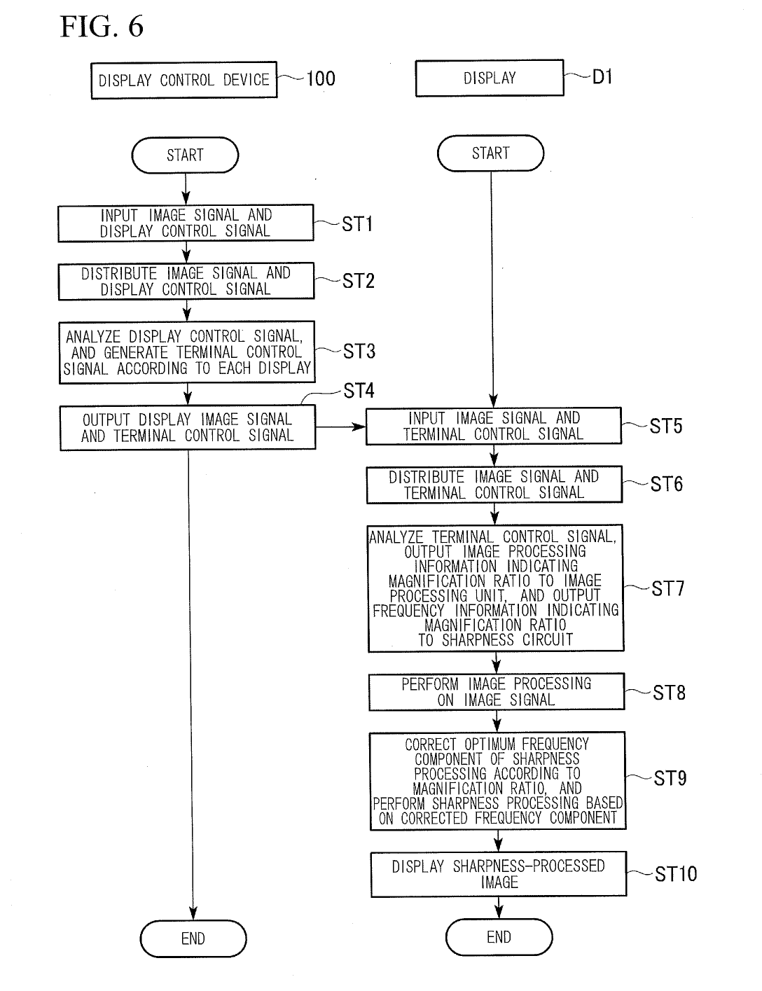

Next, a process flow of the display system according to the present exemplary embodiment is described, with reference to FIG. 6. FIG. 6 is a flow chart showing an example of a process flow of the display system according to the present exemplary embodiment.

Here, it is preliminarily set to function as a parallel connection display system. Moreover, there is described an example of a process in which this display system displays, on the displays D1 to D4, an image magnified by two times the image size to suit the multi-screen MG as shown in FIG. 5(c).

For example, in the image supply device 200, if there is specified an image signal to be displayed on the displays D1 to D4, a display position on the multi-screen MG, a magnification ratio, and a sharpness level, the display control device 100 receives from the image supply device 200 an input of a display control signal including display position information, display magnification ratio information, and display sharpness level information, together with an image signal (step ST1). Here, the display control signal includes display position information indicating display positions “A to D: signifying all screens”, display magnification ratio information indicating the magnification ratio “two times”, and a display sharpness level indicating the sharpness level “+1”.

The signal differential unit 11 that has received input of these image signal and display control signal distributes these image signal and display control signal to thereby output the image signal to the image signal distribution unit 12, and the display control signal to the control signal analysis distribution unit 13 (step ST2).

The control signal analysis distribution unit 13 analyzes the display control signal input from the signal analysis unit 11.

The control signal analysis distribution unit 13 obtains terminal position information indicating respective display positions A to D as display positions of the image to be displayed on the respective displays D1 to D4, based on the display position information included in the display control signal. Moreover, the control signal analysis distribution unit 13 obtains terminal magnification ratio information that indicates a magnification ratio “2” as the magnification ratio of the image size to be displayed on the respective displays D1 to D4, based on the display magnification ratio information included in the display control signal. Furthermore, the control signal analysis distribution unit 13 obtains terminal sharpness level information that indicates a sharpness level “+1” as the sharpness level of the image to be displayed on the respective displays D1 to D4, based on the display sharpness level information included in the display control signal.

As described above, the control signal analysis distribution unit 13 obtains by analysis, the terminal position information, terminal magnification ratio information, and terminal sharpness level information, for each terminal control information to be output to the respective displays D1 to D4 (step ST3), and outputs them to the respective displays D1 to D4. Moreover, the image signal distribution unit 12 outputs the input image signal to each of the displays D1 to D4 (step ST4).

That is to say, the image signal distribution unit 12 outputs the same image signal to all of the displays D1 to D4. Moreover, the control signal analysis distribution unit 13 outputs to the display D1 a terminal control signal which includes terminal position information indicating a display position “A”, terminal magnification ratio information indicating a magnification ratio “two times”, and terminal sharpness level information indicating a sharpness level “+1”. Similarly, the control signal analysis distribution unit 13 outputs, respectively to the displays D2, D3, and D4, a terminal control signal which includes terminal position information indicating a display position “B”, “C”, or “D”, terminal magnification ratio information indicating a magnification ratio “two times”, and terminal sharpness level information indicating a sharpness level “+1”.

For example, the signal differential unit 21 of the display D1 receives input of the image signal and the terminal control signal (step ST5), and separates them. Then, it outputs the image signal to the image processing unit 22, and outputs the terminal control signal to the control signal analysis unit 23 (step ST6).

The control signal analysis unit 23 analyzes the input terminal control signal, and outputs image processing information including the terminal magnification ratio information and the terminal position information obtained by analysis, to the image processing unit 22, and outputs frequency information including the terminal magnification ratio information and the terminal sharpness level information obtained by analysis, to the frequency variable type sharpness circuit 24 (step ST7).

The image processing unit 22 performs image processing on the image signal for magnifying the image size, based on the terminal magnification ratio information included in the image processing information, and it cuts out the image of a corresponding portion in the image signal, based on the terminal position information included in the image processing information (step ST8). That is to say, the image processing unit 22 in the display D1 magnifies the image size by two times based on the image signal, and performs image processing for cutting out a top left portion of the quarters of this image. Then the image processing unit 22 outputs the image-processed image signal to the frequency variable type sharpness circuit 24.

Next, the frequency variable type sharpness circuit 24, based on the terminal sharpness level information included in the frequency information input from the control signal analysis unit 23, reads the sharpness frequency characteristic corresponding to the sharpness level “+1” from the built-in storage unit. The sharpness frequency characteristic corresponding to this sharpness level “+1” is a frequency characteristic with a peak at frequency f₀ in the horizontal direction of the screen as described above.

The frequency variable type sharpness circuit 24 makes a change to the read sharpness frequency characteristic according to the magnification ratio indicated by the terminal magnification ratio information, and based on the sharpness frequency characteristic after the change, performs sharpness processing for emphasizing the frequency component of the image signal input from the image processing unit 22. That is to say, the frequency variable type sharpness circuit 24 obtains a sharpness frequency characteristic after the change, which takes as a peak value, a frequency f₀/2 obtained by dividing the peak value frequency f₀ by the magnification ratio “2” indicated by the terminal magnification ratio information. The frequency variable type sharpness circuit 24, based on this sharpness frequency characteristic after the change, performs sharpness processing for emphasizing the frequency component including the frequency f₀/2, on the image signal that has undergone the image processing for magnifying the image size by two times (step ST9).

As result, sharpness at a sharpness level “+1” is applied to the image signal as described above.

The frequency variable type sharpness circuit 24 outputs the sharpness-processed image signal to the display unit 25.

The display unit 25 displays the image on the screen G1 based on the image signal input from the frequency variable type sharpness circuit 24 (step ST10).

As described above, the frequency variable type sharpness circuit 24 performs the sharpness processing on the image signal magnified by the image processing unit 22, based on the frequency characteristic that has been changed according to the magnification ratio.

As a result, the problem described using FIG. 5 is solved, and sharpness can be applied even to an image signal that has undergone image processing for magnifying the image size.

Moreover, since the frequency variable type sharpness circuit 24 performs sharpness processing on the image signal that has been image-processed by the image processing unit 22, it is possible to display on the display unit 25 an image that has been sharpness-processed at an appropriate sharpness level. On the other hand, unlike the present invention, in the case where sharpness processing is performed before the image processing unit performs the image processing, there is a possibility that the image quality may be deteriorated as a result of the image processing, and it becomes difficult to display an image of a required image quality on the display unit 25.

### Second Exemplary Embodiment

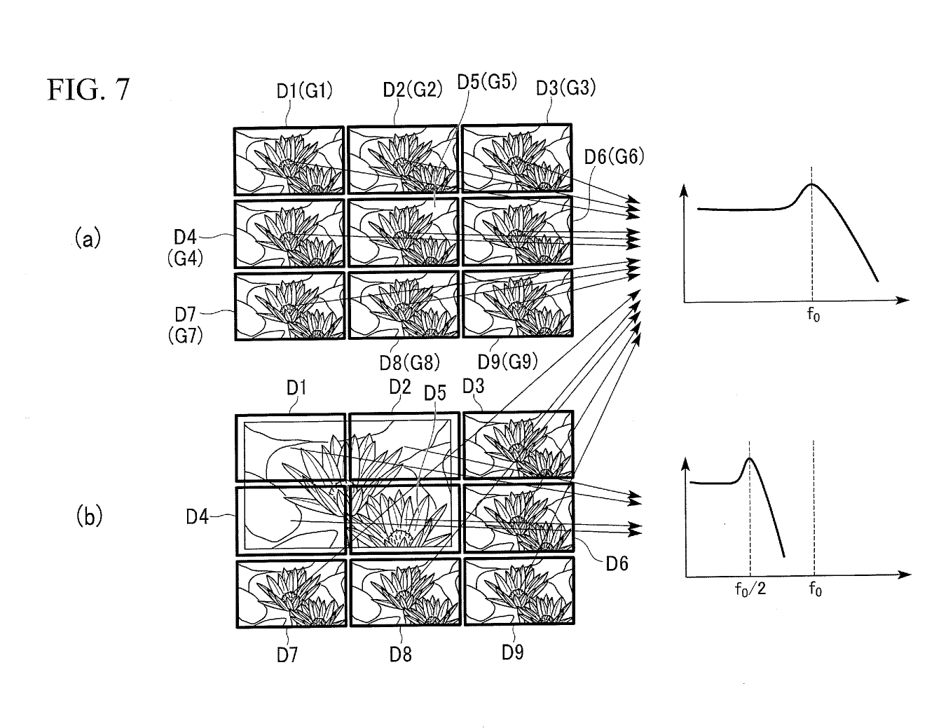

Next, a second exemplary embodiment according to the present invention is described, with reference to FIG. 7. FIG. 7 is a diagram for describing the second exemplary embodiment.

A display system according to the present exemplary embodiment is such that when the magnification ratio of the image size to be displayed on a plurality of displays is different, sharpness processing according to the magnification ratio of each screen size is performed. The display system according to the present exemplary embodiment has the same configuration and function as the first exemplary embodiment described above, except it differs in the number of displays that constitute the multi-screen MG. Therefore, detailed descriptions thereof are omitted.

As shown in FIG. 7, the display system of the present exemplary embodiment is configured with nine displays D1 to D9 in an arrangement in which three displays are arranged in the horizontal direction and three displays are arranged in the vertical direction.

These displays D1 to D9 respectively include screens G1 to G9 of the same size for example. The screens G1 to G3, screens G4 to G6, and screens G7 to G9 are respectively arranged in the horizontal direction, and the screens G1, G4, and G7, screens G2, G5, and G8, and screens G3, G6, and G9 are respectively arranged in the vertical direction. All of these screens G1 to G9 constitute a single multi-screen MG.

As shown in FIG. 7(a), in the case where an image of the same image size is displayed on each of the displays D1 to D9, the display control device 100 outputs the same image signal and the same terminal control signal to each of the displays D1 to D9.

As shown in FIG. 7(b), in the case where a single screen is displayed on the displays D1, D2, D4, and D5 while the image size thereof is magnified by “two times”, and an image of the image size “one time”, which differs from the above magnification ratio, is displayed on the displays D3, and D6 to D9, the display control device 100 outputs the same image signal and different terminal control signals to the respective displays D1 to D9.

Next, is a description of a process flow for displaying images of different magnification ratios of the image size on the multi-screen MG as shown in FIG. 7(b).

Here, it is assumed that each of the displays D1 to D9 is connected to the display control device 100, and the display control device 100 is preliminarily set to function as a parallel connection display system. Moreover, in this display system, as shown in FIG. 7(b), it is assumed that instruction signal is input to the image supply device 200 that instructs to display the image of the image size magnified by two times to suit the screen configured with the displays D1, D2, D4, and D5, and display a non-magnified image on each of the displays D3 and D6 to D9. Furthermore, display positions corresponding to the screens G1 to G9 of the displays D1 to D9 are treated respectively as display positions A to I.

For example, the image supply device 200 is instructed to display a single image of the image size magnified by two times in a region configured with the screens G1, G2, G4, and G5 of the displays D1, D2, D4, and D5 (hereunder, referred to as partial multi-screen BMG), and display a non-magnified image respectively on the screens G3 and G6 to G9 of the displays D3 and D6 to D9. Moreover, as the sharpness level of the image to be displayed on each of the displays D1 to D9, a sharpness level “+1” is specified for example.

Accordingly, the image supply device 200 associates a display control signal S101 including a display control signal that includes: display position information indicating the display positions A, B, D, and E of the partial multi-screen BMG; display magnification ratio information indicating the magnification ratio “two times” at the display positions; and display sharpness level information indicating the sharpness level “+1”, with an image signal S102 of the instructed image, and outputs them to the display control device 100.

Moreover, the image supply device 200 associates a display control signal S103 including a display control signal that includes: display position information indicating the display positions C and F to I of the screens G3 and G6 to G9 of the multi-screen MG; display magnification ratio information indicating the magnification ratio “one time” at the display positions; and display sharpness level information indicating the sharpness level “+1”, with an image signal S104 of the instructed image, and outputs them to the display control device 100.

The signal differential unit 11 of the display control device 100 receives input of these display control signals S101 and S103, and the image signal S102 and S104, outputs the image signals S102 and S 104 to the image signal distribution unit 12, and outputs the display control signals S101 and S103 to the control signal analysis distribution unit 13.

The control signal analysis distribution unit 13 analyzes the display control signals S101 and S103 input from the signal analysis unit 11.

For example, the control signal analysis distribution unit 13 obtains terminal position information indicating respective display positions A, B, D, and E as display positions of the image to be displayed on the respective displays D1, D2, D4, and D5, based on the display position information included in the display control signal S101. Moreover, the control signal analysis distribution unit 13 obtains terminal magnification ratio information that indicates a magnification ratio “2” as the magnification ratio of the image size to be displayed on the respective displays D1, D2, D4, and D5 based on the display magnification ratio information included in the display control signal S101. Furthermore, the control signal analysis distribution unit 13 obtains terminal sharpness level information that indicates a sharpness level “+1” as the sharpness level of the image to be displayed on the respective displays D1, D2, D4, and D5, based on the display sharpness level information included in the display control signal S101.

The control signal analysis distribution unit 13 outputs a terminal control signal S201 that includes the terminal position information, terminal magnification ratio information, and terminal sharpness level information, to the respective displays D1, D2, D4, and D5.

Moreover, the control signal analysis distribution unit 13, similarly, obtains terminal position information corresponding to the respective displays D3 and D6 to D9 (display positions “C and F to I”), terminal magnification ratio information (magnification ratio “one time”), and terminal sharpness level information (sharpness level “+1”), based on the display position information, the display magnification ratio information, and the display sharpness level information included in the display control signal S103. The control signal analysis distribution unit 13 outputs a terminal control signal S203 that includes the terminal position information, terminal magnification ratio information, and terminal sharpness level information, to the respective displays D3 and D6 to D9.

On the other hand, the image signal distribution unit 12 duplicates the input image signal S102 and outputs them to the respective displays D1, D2, D4, and D5, and duplicates the input image signal 5104 and outputs them to the respective displays D3 and D6 to D9.

The signal differential unit 21 of the display D1 for example receives an input of the image signal S102 and the terminal control signal S201 and outputs the image signal S102 to the image processing unit 22, and outputs the terminal control signal S201 to the control signal analysis unit 23.

The control signal analysis unit 23 analyzes the input terminal control signal S201, and outputs to the image processing unit 22 image processing information that includes the terminal magnification ratio information (magnification ratio “two times”) and the terminal position information (display positions “A, B, D, and E”) obtained by analysis. Further, it outputs to the frequency variable type sharpness circuit 24, frequency information that includes the terminal magnification ratio information (magnification ratio “two times”) and the terminal sharpness level information (sharpness level “+1”) obtained by analysis.

The image processing unit 22 magnifies the image size by two times based on the image signal S102, and performs image processing for cutting out a top left portion of the quarters of this image. This image-processed image signal is referred to as S202.

Specifically, based on the terminal position information (display position “A, B, D, and E”), the image processing unit 22 makes reference to the display position “A” pre-assigned to itself (for example, stored in the built-in storage unit), to determine that the image to be displayed on its own screen G1 is the image corresponding to the top left portion of the quarterly divided image.

Then the image processing unit 22 outputs the image-processed image signal S202 to the frequency variable type sharpness circuit 24.

Next, in a similar manner to that described above, the frequency variable type sharpness circuit 24 makes a change to the sharpness frequency characteristic corresponding to the sharpness level “+1” according to the magnification ratio “two times” indicated by the terminal magnification ratio information, and based on the sharpness frequency characteristic after the change, performs sharpness processing for emphasizing the frequency component of the image-processed image signal S202. That is to say, the frequency variable type sharpness circuit 24, based on this sharpness frequency characteristic after the change, performs sharpness processing for emphasizing the frequency component including the frequency f₀/2, on the image signal S202 that has undergone the image processing for magnifying the image size by two times.

As result, sharpness at a sharpness level “+1” is applied to the image signal S202 as described above.

The frequency variable type sharpness circuit 24 outputs the sharpness-processed image signal to the display unit 25. The display unit 25 displays the image on the screen G1 based on the image signal input from the frequency variable type sharpness circuit 24.

Moreover, the signal differential unit 21 of the display D3 for example receives an input of the image signal S104, and the terminal control signal S203, and outputs the image signal S104 to the image processing unit 22 and outputs the terminal control signal S203 to the control signal analysis unit 23.

The control signal analysis unit 23 analyzes the input terminal control signal S203, and outputs to the image processing unit 22, image processing information that includes the terminal magnification ratio information (magnification ratio “one time”) and the terminal position information (display positions “C, and F to I”) obtained by analysis. Further, it outputs to the frequency variable type sharpness circuit 24, frequency information that includes the terminal magnification ratio information (magnification ratio “one time”) and the terminal sharpness level information (sharpness level “+1”) obtained by analysis.

The image processing unit 22 determines the necessity of image processing, based on the image signal S104, and since there is terminal magnification ratio information (magnification ratio “one time”), it determines that image processing such as image size change and cutting out are not necessary. Then the image processing unit 22 outputs the image signal S104 to the frequency variable type sharpness circuit 24 without performing image processing.

Then the image processing unit 22 outputs the image signal S104 to the frequency variable type sharpness circuit 24.

Next, based on the terminal magnification ratio information included in the frequency information, the frequency variable type sharpness circuit 24 determines whether or not any change according to the magnification ratio needs to be made to the sharpness frequency characteristic, and since there is terminal magnification ratio information (magnification ratio “one time”), it determines that no change according to the magnification ratio needs to be made to the sharpness frequency characteristic. Then, based on the sharpness frequency characteristic corresponding to the sharpness level “+1”, the frequency variable type sharpness circuit 24 performs sharpness processing for emphasizing the frequency component corresponding to the image signal S104. That is to say, the frequency variable type sharpness circuit 24 performs sharpness processing for emphasizing the frequency component including a frequency f₀, on the non-image-processed image signal S104.

As a result, sharpness at a sharpness level “+1” is applied to the image signal S104 as described above.

The frequency variable type sharpness circuit 24 outputs the sharpness-processed image signal to the display unit 25. The display unit 25 displays the image on the screen G3 based on the image signal input from the frequency variable type sharpness circuit 24.

As described above, when displaying images that are instructed to be displayed at different magnification ratios on the respective displays D1 to D9, the frequency variable type sharpness circuit 24 can perform sharpness processing on the image signal that has undergone the image processing for magnifying the image size by the image processing unit 22, based on the sharpness frequency characteristic changed according to the magnification ratio.

As a result, it is possible to solve the problem described above using FIG. 5, and match the sharpness level of the images to be displayed on each of the displays D1 to D9, even when images of different magnification ratios are to be displayed on the multi-screen MG.

### Third Exemplary Embodiment

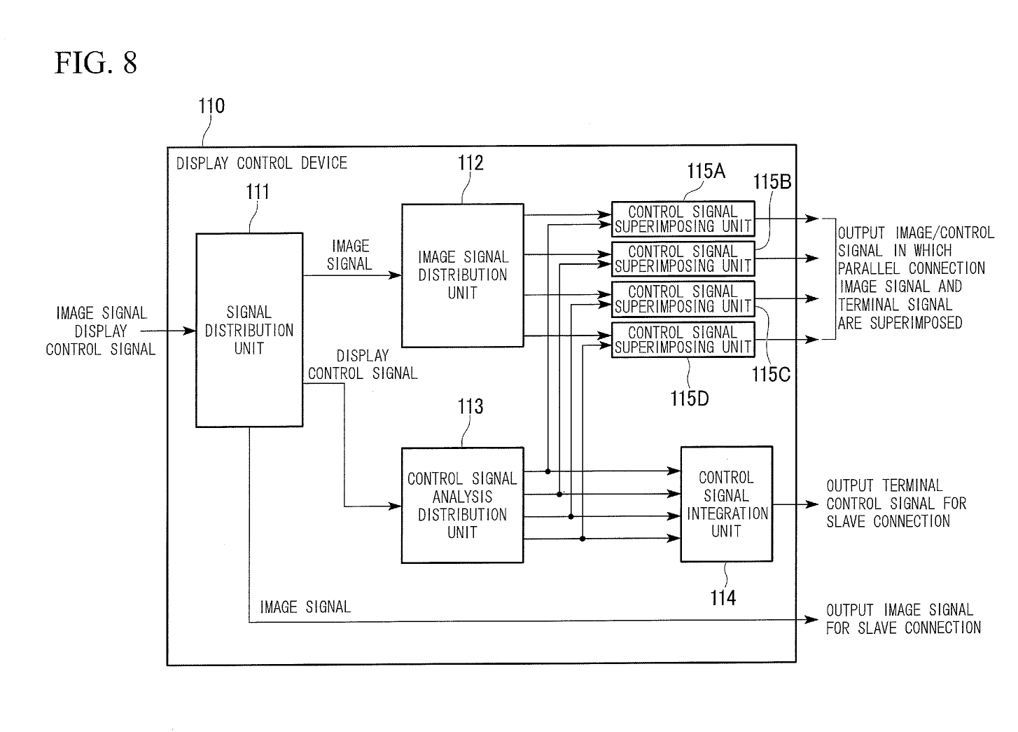

Moreover, the present invention is not limited to the above configurations, and the display control device 100 may be of the configuration shown in FIG. 8 for example.

FIG. 8 is a block diagram showing an example of a configuration of a display control device 110 that can be applied to the display control device 100.

As shown in FIG. 8, the display control device 110 includes a signal differential unit 11, a control signal integration unit 14, an image signal distribution unit 112, a control signal analysis distribution unit 113, and a plurality of control signal superimposing units 115A to 115D. Configurations similar to those described with reference to FIG. 3 are denoted by the same reference symbols, and detailed descriptions thereof are omitted.

In the case of functioning as a parallel connection display system, the image signal distribution unit 112 distributes and outputs the image signal input from the signal analysis 11 to the control signal superimposing units 115A to 115D. That is to say, the image signal distribution unit 112 duplicates an image signal and distributes them to each of the control signal superimposing units 115A to 115D.

The control signal analysis distribution unit 113 analyzes the display control signal input from the signal analysis unit 11, and distributes into terminal control signals corresponding to the respective displays D1 to D4. In the case of functioning as a parallel connection display system, the control signal analysis distribution unit 113 outputs terminal control signals corresponding to the respective displays D1 to D4 respectively to the control signal superimposing units 115A to 115D. On the other hand, in the case of functioning as a serial connection display system, the control signal analysis distribution unit 113 assigns identification information ID 1 to 4 of the respective displays D1 to D4 to the terminal control signals distributed to the respective displays D1 to D4, and outputs them to the control signal integration unit 14.

As with the control signal analysis distribution unit 13, based on the display position information, the display magnification ratio information, and the display sharpness level information included in the display control signal, the control signal analysis distribution unit 113 obtains by analysis, terminal position information, terminal magnification ratio information, and terminal sharpness level information, and outputs a terminal control signal including these types of information, to the respective control signal superimposing units 115A to 115D or to the control signal integration unit 14.

In the case of functioning as a parallel connection display system, the control signal superimposing units 115A to 115D superimpose the image signal input from the image signal distribution unit 112 on the terminal control signal input from the control signal analysis distribution unit 13, to generate an image/control signal, and outputs it to the respective displays D1 to D4. The control signal superimposing units 115A to 115D are respectively connected to the displays D1 to D4. Moreover, the plurality of control signal superimposing units 115A to 115D are configured in a number according to the number of the displays to be connected to the display control device 110, and when the displays D1 to D9 are connected in parallel to the display control device 110, they are configured with a plurality of control signal superimposing units 115A to 115I.

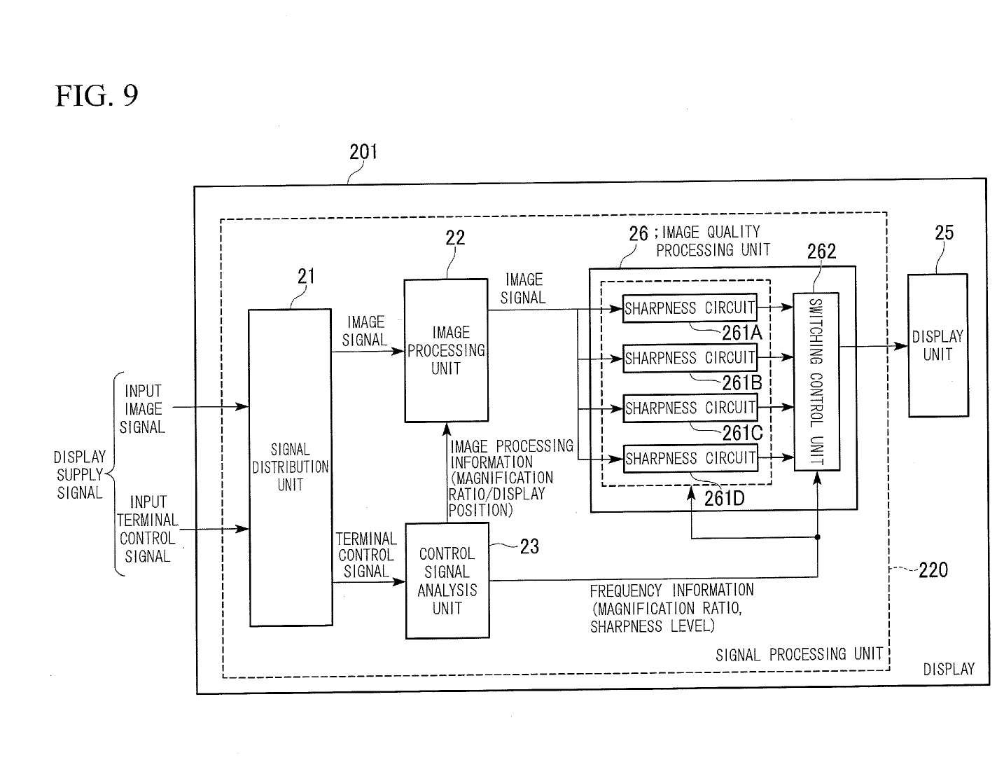

Moreover, the display according to the present invention is not limited to the above configuration described with reference to FIG. 4, and for example, it may be of the configuration shown in FIG. 9.

FIG. 9 is a block diagram showing an example of a configuration of a display 201 that can be applied to the displays D1 to D9.

As shown in FIG. 9, the display 201 includes a signal processing unit 220 and a display unit 25.

The signal processing unit 220 includes a signal differential unit 21, an image processing unit 22, a control signal analysis unit 23, and an image quality processing unit 26. Configurations similar to those described with reference to FIG. 4 are denoted by the same reference symbols, and detailed descriptions thereof are omitted.

The control signal analysis unit 23 analyzes the input terminal control signal, and obtains terminal magnification ratio information, terminal position information, and terminal sharpness level information included in the terminal control signal. The control signal analysis unit 23 outputs the terminal magnification ratio information and the terminal position information obtained by analysis, to the image processing unit 24 as image processing information. Moreover, the control signal analysis unit 23 outputs the terminal magnification ratio information and the terminal sharpness level information obtained by analysis, to the image quality processing unit 26 as frequency information.

The image processing unit 22 performs image processing on the image signal input from the signal differential unit 21, based on the image processing information input from the control signal analysis unit 23, and outputs the image-processed image signal to the image quality processing unit 26.

The image quality processing unit 26 includes a plurality of sharpness circuits 261A to 261D, and a switching control unit 262. The image quality processing unit 26 selects a sharpness circuit based on the terminal magnification ratio information and the terminal sharpness level information included in the frequency information, and outputs the image signal obtained from the selected sharpness circuit to the display unit 25.

To describe specifically, the plurality of sharpness circuits 261A to 261D are circuits each having a sharpness frequency characteristic preliminarily determined according to sharpness level and magnification ratio, and determine whether or not to perform sharpness processing on an input image signal according to the magnification ratio and sharpness level included in the frequency information input from the control signal analysis unit 23.

For example, the sharpness circuit 261A stores, in its own storage unit, sharpness frequency characteristics for performing sharpness processing at sharpness levels “+1” to “+5” on a non-magnified image signal (magnification ratio “one time”). Then when an input of the image signal is received, the sharpness circuit 261A performs on the image signal, sharpness processing according to the sharpness level indicated by the terminal sharpness level information included in the frequency information. Then, the sharpness circuit 261A outputs the sharpness-processed image signal to the switching control unit 262.

Based on the magnification ratio indicated by the terminal magnification ratio information included in the frequency information, the sharpness circuit 261A may determine whether or not this magnification ratio matches the magnification that is assigned to itself (here, magnification ratio “one time”), and if matching is determined, sharpness processing may be performed on the input image signal, and it may be output to the switching control unit 262.

Moreover, the sharpness circuit 261B stores, in its own storage unit, sharpness frequency characteristics for performing sharpness processing at sharpness levels “+1” to “+5” on an image signal of an image size magnified by two times (magnification ratio “two times”) for example. Then when an input of the image signal is received, this sharpness circuit 261B performs on the image signal, sharpness processing according to the sharpness level indicated by the terminal sharpness level information included in the frequency information. Then, the sharpness circuit 261B outputs the sharpness-processed image signal to the switching control unit 262.

Furthermore, the sharpness circuits 261C and 261D similarly store, in their own storage units, sharpness frequency characteristics for performing sharpness processing at sharpness levels “+1” to “+5” on an image signal of an image size magnified by three times or four times. These sharpness circuits 261C and 261D perform sharpness processing on an image signal of the magnified image size, based on the sharpness frequency characteristic according to each magnification ratio.

Moreover, based on the magnification ratio indicated by the terminal magnification ratio information included in the frequency information, the sharpness circuits 261B and 261D may also similarly determine whether or not this magnification ratio matches the magnification that is assigned to itself, and if matching is determined, sharpness processing may be performed on the input image signal, and it may be output to the switching control unit 262.

The sharpness frequency characteristic stored in the sharpness circuit 261A corresponds to the unchanged sharpness frequency characteristic described in the first exemplary embodiment. For example, the sharpness frequency characteristic for performing sharpness processing at a sharpness level “+1” has a frequency characteristic with a peak at frequency f₀ in the horizontal direction of the screen.

On the other hand, the sharpness frequency characteristic stored in the sharpness circuits 261B to 261D corresponds to the changed sharpness frequency characteristic described in the first exemplary embodiment. For example, the sharpness frequency characteristic for performing sharpness processing at a sharpness level “+1” on an image signal of the image size magnified by two times, three times, . . . , X times, has a frequency characteristic with a peak at frequency f₀/2, f₀/3, . . . , f₀/X in the horizontal direction of the screen.

Based on the terminal magnification ratio information of the frequency information input from the control signal analysis unit 23, the switching control unit 262 selects an image signal to be output to the display unit 25 from the image signals input from the sharpness circuits 261A to 261D, and outputs the one selected image signal to the display unit 25.

For example, in the case where the terminal magnification ratio information of the frequency information input from the control signal analysis unit 23 indicates a magnification ratio of “two times”, the switching control unit 262 outputs the image signal output from the sharpness circuit 261B to the display unit 25.

Moreover, the operation processes of each configuration of the display control devices and displays described above can be used as a program to be executed on a computer, or can be used as a program on a computer-readable recording medium, and the above processes are performed by having the computer read and execute the program. The “computer system” here includes a CPU, various types of memory devices, an OS, and hardware including peripheral devices.

Furthermore, the “computer system” includes a homepage providing environment (or a display environment) in a case where a WWW system is in use.

Moreover, the “computer-readable recording medium” refers to a re-writable nonvolatile memory such as a flexible disc, magnetic-optical disc, ROM, and flash memory, a movable medium such as CD-ROM, and a storage device such as built-in hard disc drive in a computer system.

Furthermore, the “computer-readable recording medium” also includes a type of medium capable of retaining a program for a certain period of time, such as a volatile memory (for example, DRAM: dynamic random access memory) inside a computer system serving as a server or a client in those cases where the program is transmitted via a network such as the Internet or via a communication line such as a telephone line.

Moreover, the above program may be transmitted from a computer system having this program stored on its storage device to another computer system via a transmission medium or by means of transmission waves within the transmission medium. Here, the “transmission medium” for transmitting the program refers to a medium having a function of transmitting information including a network (communication network) such as the Internet and a communication line such as a telephone line.

Furthermore, the above program may be a program for realizing part of the function described above. Moreover, it may also be a so-called difference file (difference program) which can realize the above-described function by being combined with a program already recorded on a computer system.

### REFERENCE SYMBOLS

D1 to D9: Display

100: Display control device

200: Image supply device

11: Signal differential unit

12: Image signal distribution unit

13: Control signal analysis distribution unit

14: Control signal integration unit

20: Signal processing unit

21: Signal differential unit

22: Image processing unit

23: Control signal analysis unit

24: Frequency variable type sharpness circuit (image processing unit)

25: Display unit

1. A display device comprising:
an image processing unit which receives an input of magnification ratio information indicating a magnification ratio of an image, and an image signal indicating the image, the image processing unit performing on the image signal, image processing which changes an image size of the image signal according to the magnification ratio;
an image quality processing unit which receives an input of an image signal undergone the image processing, and the magnification ratio information, the image quality processing unit changing a sharpness frequency characteristic preliminarily determined according to the image, according to the magnification ratio indicated by the magnification ratio information, the image quality processing unit performing sharpness processing which emphasizes a frequency component of the image signal undergone the image processing, based on the changed sharpness frequency characteristic; and
a display unit which includes a display screen, and displays on the display screen, an image based on the image signal sharpness-processed by the image quality processing unit.

2. A display device comprising:
an image processing unit which receives an input of magnification ratio information indicating a magnification ratio of an image, and an image signal indicating the image, the image processing unit performing on the image signal, image processing which changes an image size of the image signal according to the magnification ratio;
an image quality processing unit which includes a plurality of sharpness circuits receiving an input of the image signal undergone the image processing, and the magnification ratio information, the sharpness circuits performing sharpness processing which emphasizes a frequency component of the image signal undergone the image processing, based on a sharpness frequency characteristic preliminarily determined according to the magnification ratio, the image quality processing unit selecting one among the sharpness circuits according to the magnification ratio indicated by the magnification ratio information; and
a display unit which includes a display screen, and displays on the display screen, an image based on the image signal sharpness-processed by the sharpness circuit selected by the image quality processing unit.

3-4. (canceled)

5. A display method comprising:
an image processing step of receiving an input of magnification ratio information indicating a magnification ratio of an image, and an image signal indicating the image, and performing on the image signal, image processing which changes an image size of the image signal according to the magnification ratio;
an image quality processing step of: receiving an input of an image signal undergone the image processing, and the magnification ratio information, changing a sharpness frequency characteristic preliminarily determined according to the image, according to the magnification ratio indicated by the magnification ratio information, and performing sharpness processing which emphasizes a frequency component of the image signal undergone the image processing, based on the changed sharpness frequency characteristic; and
a displaying step of displaying on a display screen, an image based on the image signal undergone the sharpness processing.

6. (canceled)
